(19) United States
(12) Patent Application Publication
(10) Pub. No.: US 2026/0250113 A1
(43) Pub. Date: Aug. 27, 2026

(54) ON-SITE VEHICLE COMPRISING BATTERY ELEMENTS

(71) Applicant: MANITOU BF, ANCENIS (FR)

(72) Inventors: Maurice BESSEAU, ANCENIS (FR); François BROCHARD, ANCENIS (FR); Alexis POUSSET, ANCENIS (FR)

(21) Appl. No.: 18/290,715

(22) PCT Filed: Jul. 11, 2022
(86) PCT No.: PCT/EP2022/069356

§ 371 Date: May 7, 2025

(30) Foreign Application Priority Data
Jul. 20, 2021 (FR) FR2107830
Jul. 20, 2021 (FR) FR2107831

(51) Int. Cl. B66F 9/24; B60L 1/00; B60L 50/60; B66F 9/065; B66F 9/075; B66F 9/20

(52) U.S. Cl. CPC B66F 9/24; B60L 1/00; B60L 50/66; B66F 9/07572; B66F 9/205; B60L 2200/42; B66F 9/0655

(57) ABSTRACT

An on-site vehicle is provided that includes a mobile chassis, a lifting arm. battery elements, and at least one electric motor. The mobile chassis is movable over the surface of the ground. The chassis includes two parallel side rails extending parallel to a longitudinal axis of the vehicle. The lifting arm extends parallel to the longitudinal axis of the vehicle The lifting arm is articulated to the two side rails between the two side rails so as to be pivotable relative to the two side rails. The at least one electric motor is for the propulsion of the chassis and for the actuation of the lifting arm. The battery elements are electrically connected to the at least one electric motor to supply power to the at least one electric motor. The battery elements are disposed between the two side rails.

### TECHNICAL FIELD

The invention relates to an on-site vehicle including a lifting arm and battery elements for supplying electrical power to the on-site vehicle.

### Prior Art

There is known from the documentJ P 2005-262978 A an on-site vehicle including a mobile chassis movable over the surface of the ground, the chassis including two parallel side rails extending parallel to a front-to-rear axis of the vehicle and a lifting arm, the lifting arm being mounted between the two side rails so as to be mobile in pivoting relative to the two side rails.

In the documentJ P 2005-262978 A the power necessary for the on-site vehicle to function is supplied by an internal combustion engine. Now, there exists an increasingly strong demand for electrically powered on-site vehicles.

However, for on-site vehicles intended for lifting the power necessary for the propulsion of the chassis and for the actuation of the lifting arm is high.

### SUMMARY OF THE INVENTION

Some aspects of the invention stem from the observation that for the range of the electrically powered on-site vehicle not to be too low it must carry a large volume of battery elements and it is therefore necessary to find a solution for positioning the battery elements in the on-site vehicle. The overall balance of the machine depends on the distribution of the main masses, which include the battery elements. On the other hand, the battery elements must be protected against shock, in particular caused by objects falling from a height. Indeed, in the event of a shock the battery elements are liable to be damaged, which can lead to them becoming non-functional or even lead to a risk of fire or of explosion when the battery elements are lithium-ion battery elements.

One idea behind the invention consists being able to position the battery elements between the two side rails of the chassis.

In accordance with a first object the invention therefore proposes an on-site vehicle comprising:
a mobile chassis movable over the surface of the ground, the chassis including two parallel side rails extending parallel to a longitudinal direction of the vehicle; and
a lifting arm extending parallel to the longitudinal direction of the vehicle, the lifting arm being articulated to the two side rails between the two side rails so as to be mobile in pivoting relative to the two side rails about a pivot axis extending perpendicularly to the longitudinal direction of the vehicle,
the on-site vehicle being characterized in that it includes:
   at least two battery elements; and
   at least one electric motor for the propulsion of the chassis and for the actuation of the lifting arm, the battery elements being electrically connected to said at least one electric motor to supply power to said at least one electric motor; and in which the battery elements are disposed between the two side rails.

There is therefore obtained an on-site vehicle the drive train of which may be partially or even entirely electrical. Thanks to the fact that the battery elements are disposed between the two side rails between which the lifting arm is articulated, the battery elements contribute to the lateral balancing of the on-site vehicle, or at the least do not contribute significantly to any lateral imbalance of the on-site vehicle, since the center of mass of all the battery elements taken together is situated relatively near, or even exactly on, a longitudinal median axis of the on-site vehicle. Furthermore, the battery elements are situated under the lifting arm and well protected against shock, and in particular more protected against shock than if they were disposed on one side of the on-site vehicle.

Unless explicitly stated otherwise, the expression “electrically connected” includes both a direct electrical connection (with no intermediate electrical element) and an indirect electrical connection (with one or more intermediate electrical elements).

Embodiments of an on-site vehicle of this kind may have one or more of the following includes.

In accordance with one embodiment the battery elements are disposed on respective opposite sides of a longitudinal median axis of the on-site vehicle and/or straddle the longitudinal median axis of the on-site vehicle, preferably with a substantially balanced weight distribution relative to the longitudinal median axis.

Thanks to this kind of distribution the battery elements have a relatively neutral effect or even a favorable effect on the lateral balance of the vehicle. Furthermore, a globally acceptable lateral balancing of the on-site vehicle can be obtained by a balanced arrangement of the other components of the on-site vehicle. This balanced arrangement can moreover be achieved in various ways.

In accordance with one embodiment the on-site vehicle further includes a front axle mounted on a front end portion of the chassis, a rear axle mounted on a rear end portion of the chassis, and at least one transmission coupling said at least one electric motor to the front axle and/or the rear axle. Here the end portion means not only one end of the chassis but also a zone near that end. Thus the chassis may include a portion overhanging in front of the front axle and/or to the rear of the rear axle.

In accordance with one embodiment the battery elements are disposed between the front axle and the rear axle in the longitudinal direction.

The propulsion of the on-site vehicle and the actuation of the lifting arm may be partially or even entirely electrical.

For its propulsion the vehicle may include a drive axle or two drive axles. The drive axle may be a front axle or a rear axle.

For driving an axle the vehicle may employ one or more electric motors coupled by a mechanical transmission to the axle, in other words an electromechanical drive train. The mechanical transmission may include one or more elements chosen from the group consisting of: a gearbox, a transmission shaft and a universal joint. The electric motor may be a motor dedicated to propulsion.

Alternatively, for driving an axle the vehicle may employ one or more electric motors coupled by a hydraulic transmission to the axle, in other words an electrohydraulic drive train. The hydraulic transmission may include a hydraulic pump driven by the electric motor and at least one hydraulic motor driven by a hydraulic flow generated by the hydraulic pump. The hydraulic transmission may be a hydrostatic transmission, that is to say a closed-circuit transmission. The hydraulic pump and the electric motor may be dedicated to propulsion. Alternatively, the hydraulic pump and the electric motor may be shared with other hydraulic functions of the vehicle, such as a function of hydraulic actuation of the lifting arm or other function.

Where necessary, for driving two axles the machine may employ two independent drive trains or a common drive train. The two independent drive trains may be of different kinds, for example an electromechanical drive train and an electrohydraulic drive train, or of identical kinds, for example two electromechanical drive trains. The common drive train may include two drive shafts connecting the two axles to a common motor, which may be an electric motor or a hydraulic motor. The common motor may be a motor dedicated to propulsion.

In accordance with one embodiment said at least one electric motor includes an electric propulsion motor for the propulsion of the chassis, the battery elements being electrically connected to the propulsion electric motor via an electrical variable speed drive, said transmission including a mechanical or hydraulic transmission coupling said propulsion electric motor to the front axle and/or the rear axle.

In accordance with one embodiment said at least one electric motor includes a first propulsion electric motor coupled to the front axle by a first mechanical transmission and a second propulsion electric motor coupled to the rear axle by a second mechanical transmission.

In accordance with one embodiment said transmission includes a hydraulic transmission coupling said at least one electric motor to the front axle and/or the rear axle, the hydraulic transmission including at least one hydraulic pump driven by said at least one electric motor and at least one hydraulic motor driven by a hydraulic flow generated by said hydraulic pump, said at least one hydraulic motor being coupled to the front axle and/or the rear axle.

For the actuation of the lifting arm the vehicle may include one or more electric actuators, i.e. electric actuation by an electric cylinder, for example, and/or one or more hydraulic actuators fed by one or more pumps driven by one or more electric motors, i.e. electrohydraulic actuation, for example by a hydraulic cylinder. A plurality of actuators of different kinds, for example at least one electric actuator and at least one hydraulic actuator, or of identical kinds, for example a plurality of hydraulic actuators, may be provided for actuating different movements or degrees of freedom of the lifting arm. For example, the various movements may be chosen in the group consisting of: an up-down movement, an extension-retraction movement and a movement of inclination of a tool-carrier.

In accordance with one embodiment said at least one electric motor includes an actuator electric motor for actuation of the lifting arm, the battery elements being connected to the actuator electric motor via an electric variable speed drive.

In accordance with one embodiment the at least one actuator electric motor includes at least one electric cylinder configured to actuate at least one movement of the lifting arm.

In accordance with one embodiment the on-site vehicle further includes a hydraulic pump coupled to the actuator electric motor and to at least one hydraulic actuator fed by the hydraulic pump to actuate at least one movement of the lifting arm.

In the case of electrohydraulic actuation of one or more movements of the lifting arm and electrohydraulic driving of one or more axles, independent hydraulic pumps may be employed or a common hydraulic pump may be employed. Independent hydraulic pumps may be driven by respective electric motors.

In all cases the battery elements may be electrically connected to a single electric motor or to a plurality of electric motors to supply power to said electric motor(s) for the propulsion of the chassis and for the actuation of the lifting arm.

In accordance with one embodiment the on-site vehicle further includes a cab for a driver of the on-site vehicle, the cab projecting on one lateral side of the chassis of the on-site vehicle.

The weight of the cab may be balanced in various ways, in particular independently of the weight of the battery elements that are situated between the two side rails of the on-site vehicle. For example, the weight of the cab may be balanced by elements situated in a compartment projecting from a second lateral side of the chassis of the on-site vehicle, opposite the cab. Those elements may include a propulsion electric motor, an actuator electric motor, a hydraulic pump, a tank of hydraulic liquid and/or other elements.

The electric motor or motors may be disposed at various locations in the on-site vehicle. In accordance with one embodiment a propulsion electric motor and/or an actuator electric motor is situated between the two side rails or under the two side rails.

In accordance with one embodiment the chassis includes a housing receiving the battery elements, the housing having an opening that opens in a direction chosen from the front of the on-site vehicle, the rear of the on-site vehicle, the upper side of the chassis, the underside of the chassis and a lateral direction away from a cab of the on-site vehicle.

In accordance with one embodiment the housing has a lower surface on which the battery elements rest directly or indirectly.

By “resting directly” is meant that the battery elements rest on the lower surface with no part disposed between the battery elements and the lower surface. Conversely, by “resting indirectly” is meant that at least one part is disposed between the lower surface and the battery elements.

In accordance with one embodiment the lower surface is inclined toward the surface of the ground in a direction away from the opening.

In accordance with one embodiment the opening of the housing is closed by a ventilation grill.

In accordance with one embodiment the housing includes a ventilation orifice at a distance from the opening that may be situated at an end opposite the ventilation grill or elsewhere.

These features enable creation of a convection of air around the set of batteries that tends to limit the risk of accidental overheating of the constituent battery elements.

In accordance with one embodiment a shaft of a propulsion electric motor extends under the housing.

In accordance with one embodiment the on-site vehicle further includes supplementary battery elements for supplying electrical power to said at least one electric motor of the on-site vehicle, the supplementary battery elements being disposed between the two side rails, and the chassis includes a supplementary housing receiving the supplementary battery elements, the supplementary housing including an opening that opens toward the rear of the on-site vehicle and a lower surface on which the supplementary battery elements rest directly or indirectly.

The supplementary battery elements make it possible to increase the range and/or the power of the on-site vehicle.

In accordance with one embodiment the supplementary battery elements rest on a plate, the plate resting on the lower surface of the supplementary housing and featuring a rim that blocks the opening of the supplementary housing when the supplementary battery elements are received in the supplementary housing.

In accordance with one embodiment the lower surface of the supplementary housing is inclined toward the surface of the ground in a direction away from the opening of the supplementary housing.

In accordance with one embodiment the rim is provided with at least one ventilation grill.

In accordance with one embodiment the supplementary housing includes a ventilation orifice at an end opposite said at least one ventilation grill of the rim.

Embodiments of the battery elements may be provided in the form of a set of batteries conforming to a second object of the invention.

Another idea behind the invention is to propose sets of batteries that can be easily inserted between the two side rails.

In accordance with the second object the invention therefore proposes a globally parallelepipedal set of batteries configured to supply electrical power to an on-site vehicle,
the set of batteries including:
   a support plate;
   at least two battery elements fixed to an upper face relative to a heightwise direction of the set of batteries;
   an electrical connection unit electrically connected to the battery elements; and
   a power outlet socket electrically connected to an output of the electrical connection unit and electrically connectable to a power input socket of the on-site vehicle, the set of batteries having a greatest width [symbol] in a widthwise direction of the set of batteries, a greatest length L in a lengthwise direction of the set of batteries, and a greatest height h in the heightwise direction of the set of batteries, the greatest length L being greater than the greatest width [symbol] , the greatest length L and the greatest height h satisfying the condition h/L≤0.40.

Embodiments of a set of batteries of this kind may have one or more of the following features.

In accordance with one embodiment the greatest width [symbol] and the greatest height h satisfy the condition h/ [symbol] ≤0.60.

In accordance with one embodiment the greatest length L and the greatest width [symbol] satisfy the condition [symbol] /L≤0.30.

In accordance with one embodiment the support plate includes a plurality of polymer skids on a lower face opposite the upper face to which the battery elements are fixed.

In accordance with one embodiment the support plate has at one of its ends in the lengthwise direction two through-orifices, the through-orifices being sized to allow a human operative to raise the set of batteries by said end by taking hold of the support plate through the two through-orifices.

In accordance with one embodiment the support plate carries a plurality of elements projecting in the widthwise direction and/or in the lengthwise direction, the projecting elements being adapted to cooperate with slinging elements.

In accordance with one embodiment the battery elements are lithium-ion battery elements.

In accordance with one embodiment the set of batteries further includes at least one roller mounted on and free to rotate on an upper surface of the set of batteries, the roller being intended to roll against a surface of the on-site vehicle during movement of the set of batteries in the lengthwise direction.

In accordance with one embodiment the support plate includes a plurality of openings, the openings being aligned with one another in the lengthwise direction of the set of batteries and arranged so as to be able to cooperate with a toothed wheel during movement of the support plate in the lengthwise direction.

In accordance with one embodiment the set of batteries further includes a projecting stud at one longitudinal end of the set of batteries, the projecting stud being intended to cooperate with a centering orifice situated in the on-site vehicle.

In accordance with one embodiment the invention also proposes an on-site vehicle conforming to any of the embodiments described hereinabove in which the set of batteries conforms to any of the embodiments that have just been described and the set of batteries is disposed between the two side rails.

In accordance with one embodiment the housing receiving the set of batteries has an upper surface facing the lower surface, the upper surface including an inclined flat so that a cross section of the housing widens in the direction toward the opening.

In accordance with one embodiment the set of batteries includes the at least one freely rotatable roller mentioned hereinabove and the roller is adapted to cooperate with the inclined flat when the set of batteries is extracted from the housing by the opening of the housing.

In accordance with one embodiment the set of batteries includes the plurality of openings mentioned hereinabove and the chassis includes a shaft situated in the vicinity of the opening of the housing, the shaft carrying a toothed wheel adapted to be able to cooperate with the openings in the support plate and thus to move the support plate in translation when the shaft is driven in rotation.

In accordance with one embodiment the set of batteries includes the projecting stud mentioned hereinabove, the projecting stud being received in a centering orifice situated at an end of the housing that is opposite the opening of the housing.

### BRIEF DESCRIPTION OF THE FIGURES

The invention will be better understood and other objects, details, features and advantages thereof will become more clearly apparent in the course of the following description of particular embodiments of the invention provided by way of non-limiting illustration only, given with reference to the appended drawings.

FIG. 1A is a perspective view of an on-site vehicle.

FIG. 1B is a partial perspective view of the rear of the on-site vehicle from FIG. 1A.

FIG. 1C is a side view of the chassis of the on-site vehicle from FIG. 1A.

FIG. 2 is a view in section of the on-site vehicle from FIG. 1A as seen from below the on-site vehicle.

FIG. 3 is a perspective view of the chassis of the on-site vehicle from FIG. 1A.

FIG. 4 is a side view of the chassis from FIG. 3, one of the side rails of the chassis having been removed in order to show the sets of batteries inserted in the chassis.

FIG. 5A is a perspective view of a set of batteries that can be inserted in the chassis from FIGS. 3 and 4.

FIG. 5B is a view of the set of batteries as seen from above.

FIG. 5C is a front view of the set of batteries.

FIG. 5D is a side view of the set of batteries.

FIG. 6A is an exploded view of a battery module that can be used to produce the set of batteries from FIG. 5A.

FIG. 6B is an exploded view of the set of batteries from FIG. 5A.

FIG. 7 is a view to a larger scale of the detail VII from FIG. 5B.

FIG. 8A is a perspective view of supplementary set of batteries that can be inserted in the chassis from FIGS. 2 and 5.

FIG. 8B is a view from above of the supplementary set of batteries.

FIG. 8C is a front view of the supplementary set of batteries.

FIG. 8D is a side view of the supplementary set of batteries.

FIG. 9 is a perspective view showing an electric motor for the propulsion of the chassis and a transmission between that electric motor and the axles.

FIG. 10 is a functional diagram representing the supply of electrical power to the on-site vehicle from FIGS. 1 to 5 by means of the set of batteries and the supplementary set of batteries.

FIG. 11A is a partial perspective view of the front of the on-site vehicle from FIG. 1A showing the set of batteries partially extracted from the chassis.

FIG. 11B is a partial perspective view showing the fixing of the set of batteries to the front of the chassis.

FIG. 11C is a partial perspective view showing the fixing of the set of batteries to an internal part of the chassis.

FIG. 12 is a partial perspective view showing the fixing of the supplementary set of batteries to an internal part of the chassis.

FIG. 13A is a perspective view from above showing a variant of the set of batteries.

FIG. 13B is a perspective view from below of the set of batteries from FIG. 13A.

FIG. 14A is a view analogous to FIG. 11B showing the cooperation of the set of batteries from FIGS. 13A and 13B with the front of the chassis.

FIG. 14B is a view to a larger scale of the detail XIVB from FIG. 14A.

FIG. 15A is a view analogous to FIG. 4 showing the set of batteries being removed from the chassis.

FIG. 15B is a view analogous to FIG. 15A also showing the set of batteries being removed from the chassis.

FIG. 16 is a view to a larger scale of the detail XVI from FIG. 1B showing the fixing of the supplementary set of batteries to the rear of the chassis.

FIG. 17 is a partial perspective view of the rear of the on-site vehicle showing the supplementary set of batteries being removed from the chassis.

FIG. 18A is a partial view in section analogous to that of FIG. 2 showing a variant of the on-site vehicle as seen from below.

FIG. 18B is a partial perspective view of the on-site vehicle from FIG. 18A.

FIG. 19A is a partial view in section analogous to that of FIG. 2 showing another variant of the on-site vehicle as seen from above.

FIG. 19B is a partial perspective view of the on-site vehicle from FIG. 19A.

FIG. 20A is a partial view in section analogous to that of FIG. 2 showing a further variant of the on-site vehicle as seen from above.

FIG. 20B is a partial perspective view of the on-site vehicle from FIG. 20A.

FIG. 21 is a functional diagram representing an alternative transmission to that represented in FIG. 9.

FIG. 22 is a perspective view from below of yet another variant of the on-site vehicle.

### DESCRIPTION OF EMBODIMENTS

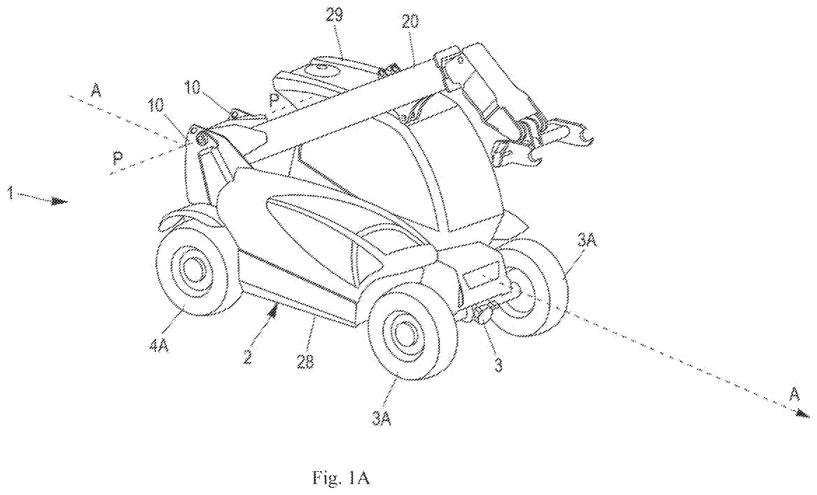

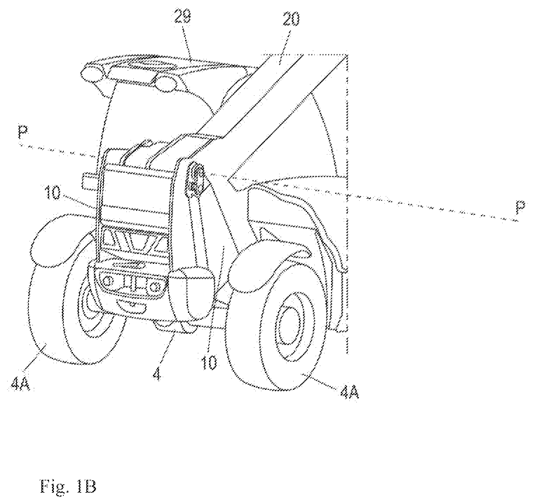

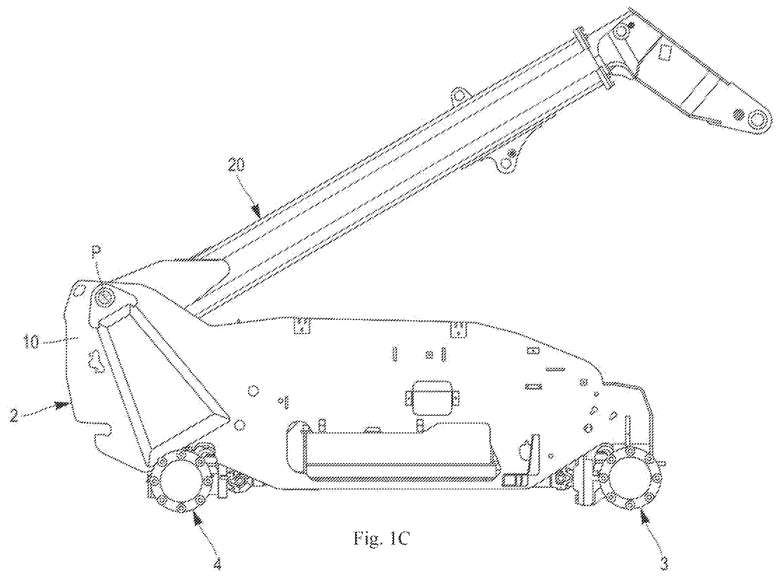

FIG. 1A is a general perspective view of an on-site vehicle 1 here taking the form of a telescopic lift truck. As represented in this figure, the on-site vehicle 1 includes a chassis 2 and a lifting arm 20. The arrow A-A represents a front-to-rear median axis of the on-site vehicle 1 aligned with the middle of the axles 3 and 4. The front-to-rear median axis corresponds to a longitudinal direction of the on-site vehicle 1. FIG. 1B is a partial view from the rear of the same on-site vehicle 1.

The chassis 2 is mobile and movable over the surface of the ground (not represented), here by means of a front axle 3 bearing two wheels 3A, one on the left and one on the right, and a rear axle 4 bearing two wheels 4A, one on the left and one on the right.

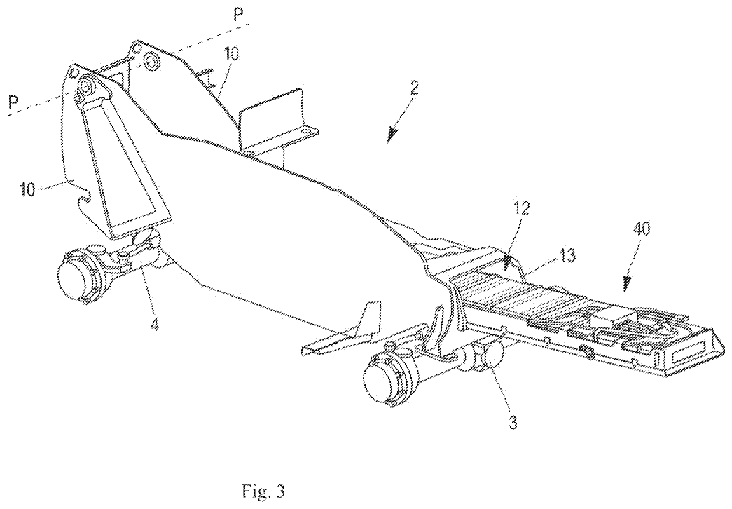

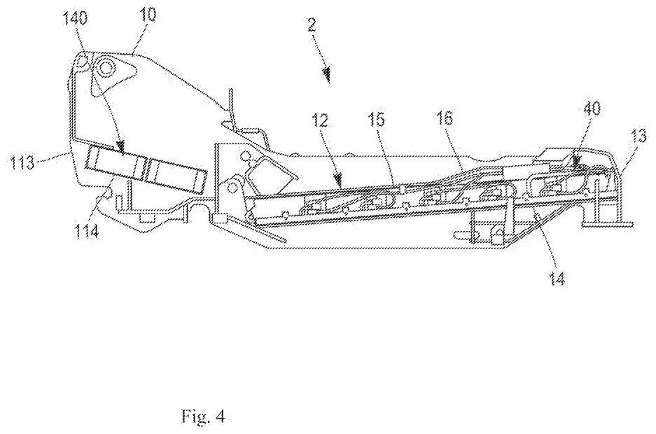

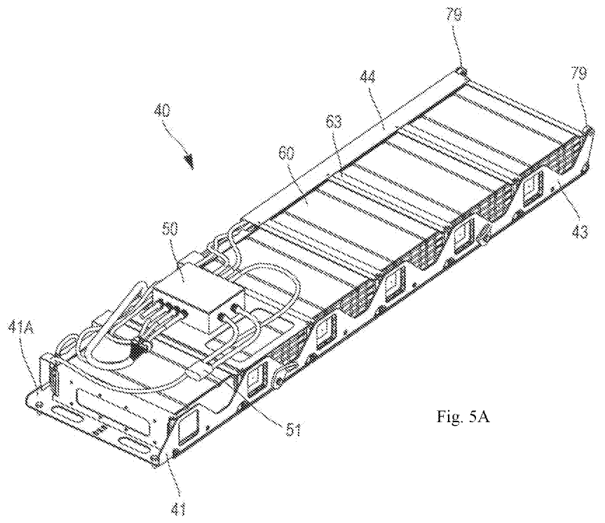

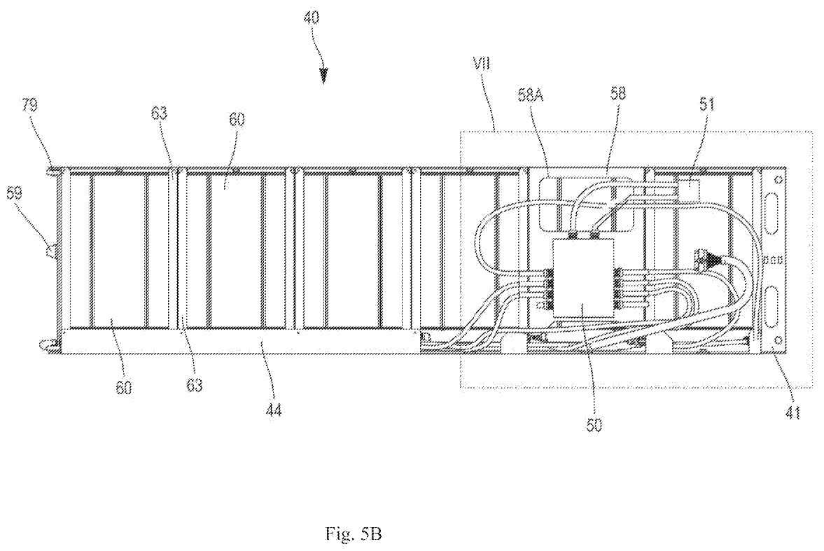

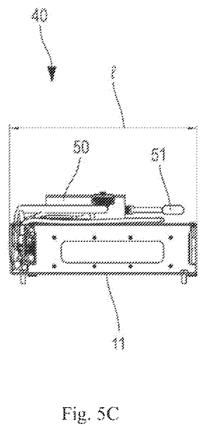

The chassis 2 includes two side rails 10 that are seen better in FIGS. 3 and 4 in particular. The side rails 10 are globally flat metal parts, parallel to one another and globally perpendicular to a widthwise direction of the on-site vehicle. The greatest dimension of the side rails 10 extends parallel to the front-to-rear axis A-A of the on-site vehicle 1.

As represented in FIG. 1A, the lifting arm 20 also extends in a plane perpendicular to the widthwise direction of the on-site vehicle. The lifting arm 20 is articulated to the two side rails 10, between the two side rails 10, so as to be mobile in pivoting relative to the two side rails 10 about a pivot axis P. The pivot axis P is identified in FIG. 1A in particular. The pivot axis P is parallel to the widthwise direction of the on-site vehicle 1.

The means for rendering the lifting arm 20 mobile in pivoting are well known as such and are not described in detail here.

The lifting arm 20 may be produced in various ways, in particular in the form of a plurality of telescopic sections as represented here, or in a variant in the form of an arm of fixed length. An end of the lifting arm 20 opposite the pivot axis P is able to carry a working tool or, as represented in FIG. 1A, a modular tool-carrier able to receive working tools of a number of types, in accordance with the known technique. By working tool is meant for example a pair of forks, a bucket, a winch, a grab, etc.

It is also seen in FIG. 1A that the on-site vehicle 1 includes a cab 29 in which a driver of the on-site vehicle 1 can take their place and a box 28 able to receive various equipment serving the operation of the on-site vehicle 1. The cab 29 and the box 28 are situated here on respective opposite sides of the side rails 10, i.e. the cab 29 is situated on a first lateral side of the on-site vehicle 1 and the box 28 is situated on a second lateral side of the on-site vehicle, the first lateral side and the second lateral side being on respective opposite sides of the two side rails 10.

Referring to FIG. 1C, the pivot axis P is situated to the rear of the rear axle 4 along the front-to-rear axis A-A. It is moreover situated higher than the front axle 3 and the rear axle 4 in a vertical direction of the on-site vehicle 1.

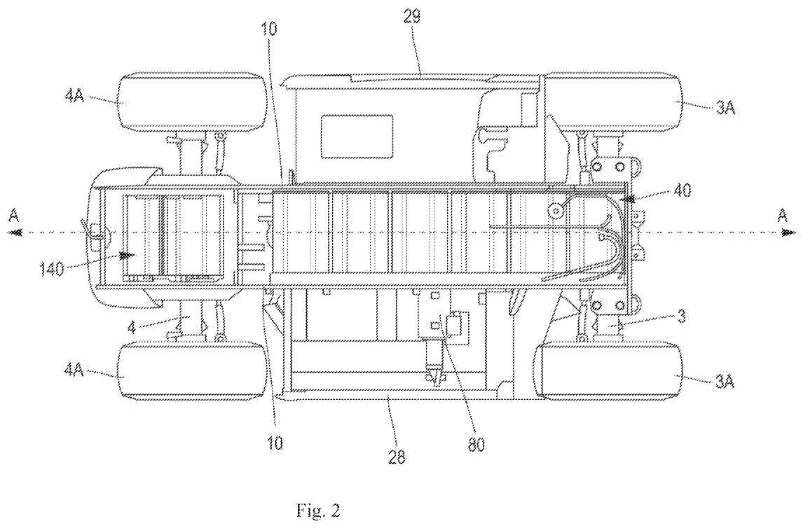

FIG. 2 is a view from below of the on-site vehicle 1. As represented in this figure, a set of batteries 40 is disposed between the two side rails 10. The set of batteries 40 is connected to at least one electric motor of the on-site vehicle 1 in order to supply that at least one electric motor with electricity. There has been represented in FIG. 2 an electric motor 80 for the propulsion of the chassis 2. The transmission of power between the set of batteries 40, the electric motor 80 and the axles 3 and 4 is described in detail later.

An optional supplementary set of batteries 140 is also disposed between the two side rails 10. This supplementary set of batteries 140 is also connected to said at least one electric motor of the on-site vehicle 1 in order to supply that at least one electric motor with electricity. The supplementary set of batteries 140 enables the range of the on-site vehicle 1 to be increased.

The set of batteries 40, and where applicable the supplementary set of batteries 140, is/are produced by combining a plurality of battery elements so as to achieve a voltage at the terminals sufficient for the on-site vehicle 1 to function without the on-site vehicle 1 having to carry another drive train such as an internal combustion engine. The battery elements may in principle be of any known type, for example of the lead-acid type or the lithium-ion type, and may be combined and installed between the side rails 10 in various ways.

Nevertheless, the space between the side rails 10 may be somewhat difficult to access, depending on the dimensions of the on-site vehicle 1. Described hereinafter with reference to FIGS. 3 to 17 are various solutions enabling easy insertion and withdrawal of the set of batteries 40 and the supplementary set of batteries 140 between the two side rails 10.

FIGS. 5A to 5D are views of a set of batteries 40 that can be inserted between the two side rails 10. FIG. 3 shows by way of illustration this set of batteries 40 being inserted between the side rails 10, here from the front of the on-site vehicle 1.

As represented in FIGS. 5A to 5D, the set of batteries 40 is globally parallelepipedal in shape and includes a support plate 41 and a plurality of battery elements 60 fixed to an upper face 41A of the support plate 41.

The support plate 41 is rigid and can be made of any material strong enough to support the weight of the battery elements 60, for example steel.

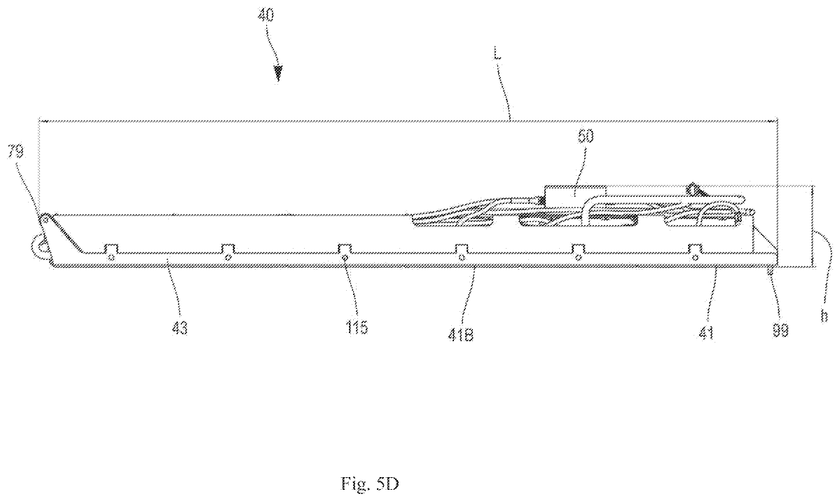

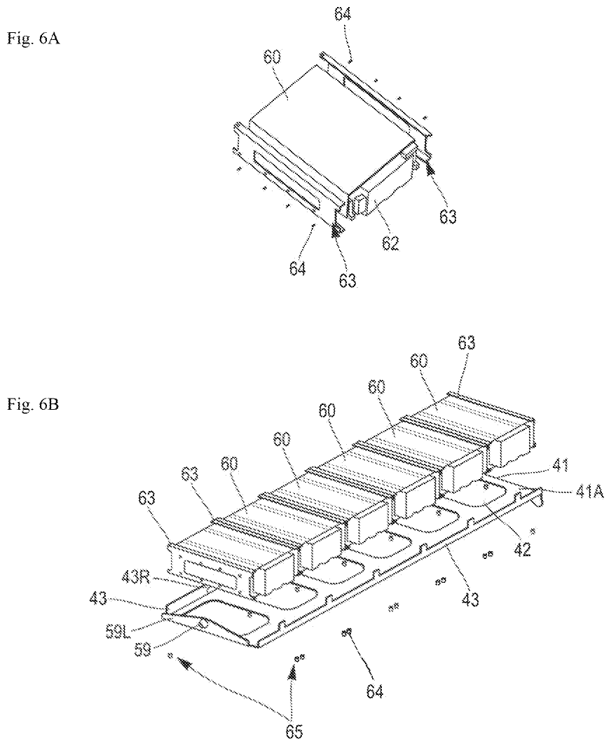

FIGS. 6A and 6B are exploded views that more particularly show the assembly of the battery elements 60 on the support plate 41. As represented in FIG. 6A, each battery element 60 includes a parallelepipedal housing 61 enclosing the electrolytic cell or cells generating the voltage at the terminals of the battery element 60. The battery element 60 is preferably of the lithium-ion type. One face of the housing 61 carries a battery management system (BMS) 62 which, as known in itself, monitors and manages the charging and the discharging of the set of electrolytic cells of the battery element 60. This battery management system 62 also carries the output terminals of the battery element 60.

Still referring to FIG. 6A, two frame elements 63 are attached to the two opposite faces of the housing 61, here by means of bolts 64.

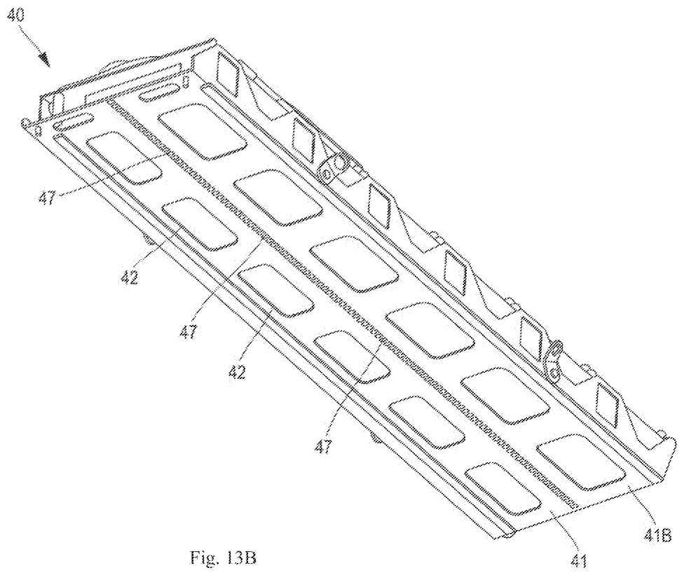

Then at least two (in FIG. 6B six) assemblies each consisting of a battery element 60 and two frame elements 63 are aligned along a lengthwise direction L of the set of batteries 40. The frame elements 63 are then attached to the support plate 41, here by means of bolts 65 the heads of which are situated on the side of the lower face 41B of the support plate 41. The battery elements 60 are therefore fixed to the upper face 41A of the support plate 41. The support plate 41 may advantageously include, for each battery element 60, one (FIG. 6B), two (FIG. 13B), or more than two ventilation openings 42 passing through the support plate 41 so as to open onto a face of the housing 61. These ventilation openings 42 make it possible to limit the risk of accidental overheating of the battery elements 60.

Numerical example: in one embodiment each battery element 60 delivers a voltage of 48 V and a power of 4.2 kW. The battery elements 60 are connected in series in pairs so that each pair supplies a voltage of 96 V. The pairs of battery elements 60 are connected in parallel to one another, i.e. three pairs in the case of six battery elements 60.

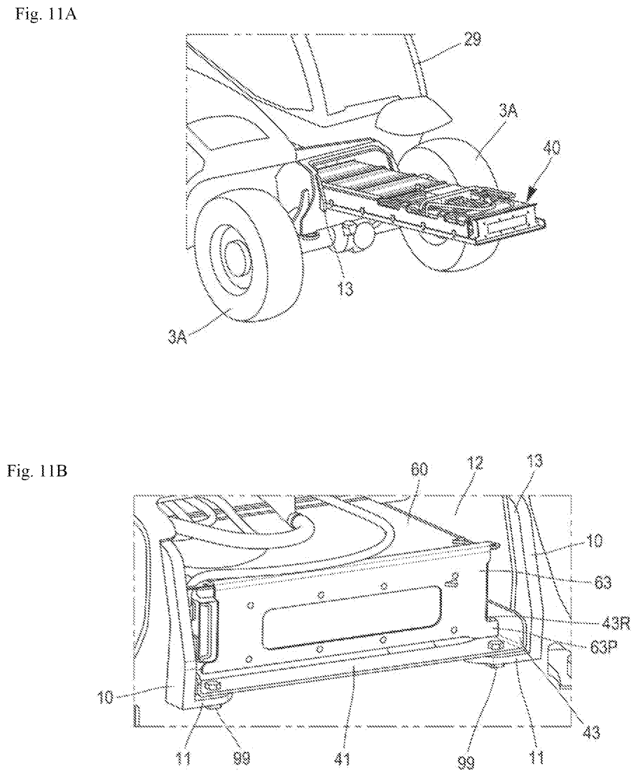

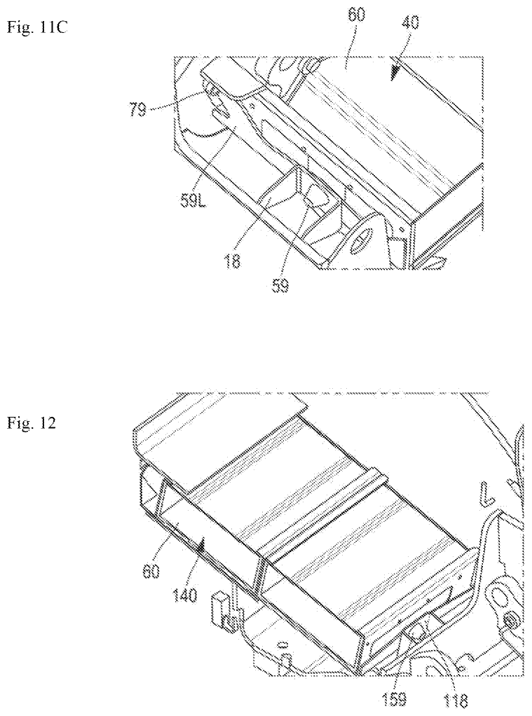

Referring to FIGS. 5A, 5D, 6B and 11B, one side of the support plate 41 may be provided with a raised edge 43 that contributes to retaining the battery elements 60 in position relative to the support plate 41. As can be seen better in FIG. 11B, this raised edge 43 may be provided with through-orifices 43R, each through-orifice 43R receiving a projecting portion 63P of a frame element 63. The raised edge 43 may be produced in various ways, either in the form of a part attached to the support plate 41 or in one piece with the support plate 41.

Referring again now to FIGS. 5A to 5D, after the battery elements 60 have been fixed to the support plate 41 the battery elements 60 are electrically connected to an electrical connection unit 50.

A cable guide 44 may be installed on one side of the set of batteries 40 in order to secure in place and to protect the electrical cables electrically connecting the battery elements 60 to the electrical connection unit 50. This cable guide 44 may for example be attached to some of the frame elements 63.

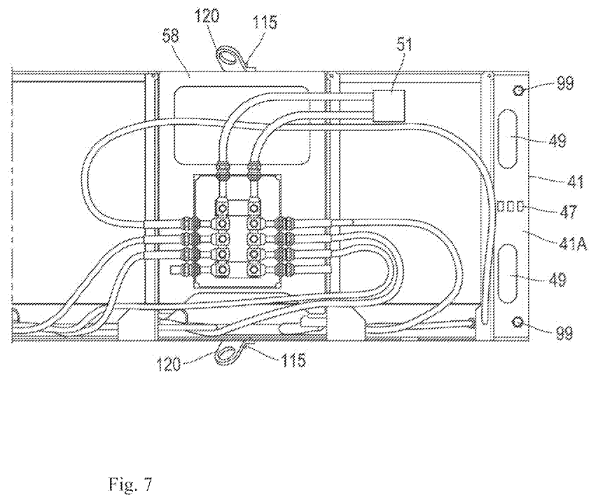

Referring to FIGS. 5A, 5B and 7, the electrical connection unit 50 may be fixed to a support plate 58 disposed between the electrical connection unit 50 and the battery elements 60. The support plate 58 may be attached to some of the frame elements 63. The support plate 58 may include a ventilation opening 58A making it possible to limit the risk of accidental overheating of the battery elements 60.

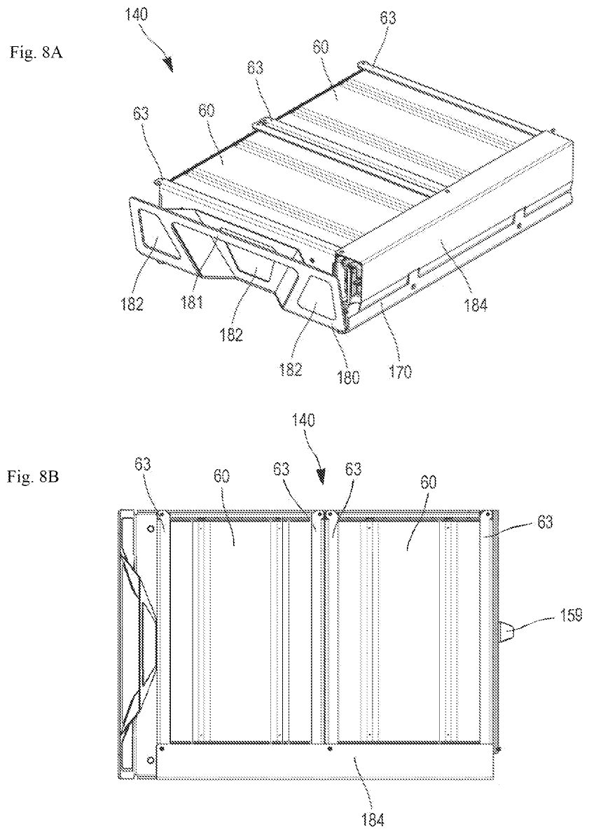

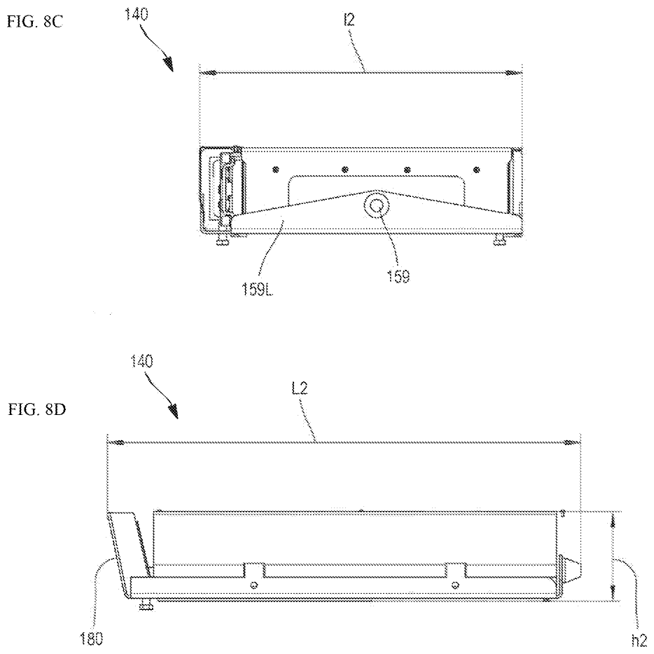

The set of batteries 40 further includes a power outlet socket 51 enabling electrical connection of the set of batteries 40 to a power input socket 400 (not represented in FIGS. 8A to 8D) of the on-site vehicle 1. The power outlet socket 51 is intended to be electrically connected to an output of the electrical connection unit 50.

After the battery elements 60 and the electrical connection unit 50 have been fixed to the support plate 41, the battery elements 60 have been electrically connected to the electrical connection unit 50, and the electrical connection unit 50 has been electrically connected to the power outlet socket 51, the set of batteries 40 is ready to be inserted between the two side rails 10 of the on-site vehicle 1.

Still referring to FIGS. 5A to 5D, the set of batteries 40 has a greatest width [symbol] in a widthwise direction of the set of batteries 40, a greatest length L in a lengthwise direction of the set of batteries 40, and a greatest height h in a heightwise direction of the set of batteries 40, the greatest length L being greater than the greatest width [symbol] .

The greatest length L and the greatest height h satisfy the condition h/L≤0.40. This means that h is relatively small compared to L, which gives the set of batteries 40 a relatively flat and elongate shape that makes it possible to position the set of batteries 40 in a relatively long housing 12 of relatively low height, as described hereinafter.

Furthermore, the greatest width [symbol] and the greatest height h may satisfy the condition h/ [symbol] ≤0.60, and/or the greatest length L and the greatest width [symbol] may satisfy the condition [symbol] /L≤0.30.

As mentioned hereinabove, the set of batteries 40 is configured so that it can be inserted between the two side rails 10 of the on-site vehicle 1 in a state in which the battery elements 60 are electrically connected to the electrical connection unit 50 and the electrical connection unit 50 is electrically connected to the power outlet socket 51.

For a large on-site vehicle 1 the set of batteries 40 may have a weight greater than 100 kg or even greater than 200 kg, which is too high to enable human operatives to manipulate the set of batteries 40 without tools. Some of the features described hereinafter of the set of batteries 40 and/or of the on-site vehicle 1 make it possible to facilitate manipulation and insertion of the set of batteries 40 between the side rails 10.

As can be seen better in FIG. 4, the set of batteries 40 is received in a housing 12 formed in the chassis 2 between the side rails 10. The lateral walls of the housing 12 are defined by lateral surfaces of the side rails 10. The housing 12 also has a lower surface 14 and an upper surface 15 spaced from the lower surface 14. The support plate 41 rests on the lower surface 14 when the set of batteries 40 is in place in the housing 12.

The greatest dimension of the housing 12 extends along the front-to-rear axis A-A of the on-site vehicle 1. As can be seen in the figures, the set of batteries 40 is inserted in the housing 12 so that its direction of greatest length extends along the greatest dimension of the housing 12.

In a manner that is not represented in the drawings the lower face 41B of the support plate 41 may be provided with a plurality of polymer skids in order to reduce the friction between the support plate 41 and the lower surface 14 of the housing 12 during insertion of the set of batteries 40 in the housing 12.

As can be seen better in FIGS. 3 and 11A, the housing 12 has an opening 13 that is situated at the front of the on-site vehicle 1 along the front-to-rear axis A-A.

As represented in FIG. 11B, each side rail 10 is provided with a shoulder 11 in the vicinity of the opening 13. These shoulders 11 make it possible to fix one end of the support plate 41 to the side rails 10 when the set of batteries 40 is in place in the housing 12. In the example represented in FIG. 11B the support plate 41 is fixed to the shoulders 11 by means of bolts 99, but other types of fixing may be envisaged.

As can be seen in particular in FIGS. 5B, 7 and 13A, at its longitudinal end intended to be fixed to the shoulders 11 the support plate 41 may include two through-orifices 49. The through-orifices 49 are sized to enable a human operative to raise the set of batteries by said end by seizing the support plate through the two through-orifices 49. The through-orifices 49 may be of any suitable shape, for example elliptical, rectangular, or, as represented in the drawings, in the form of a rectangle completed by two semi-circles on two opposite sides of the rectangle.

FIGS. 5B and 6B show further that at its longitudinal end opposite that featuring the through-orifices 49 the support plate 41 may be provided with a projecting stud 59 of cylindrical or more preferably frustoconical shape. Here the projecting stud 59 is carried by a longitudinal rim 59L that may be attached to the support plate 41 or formed in one piece with the support plate 41. As represented in FIG. 11C, at its end opposite the opening 13 the housing 12 includes a centering piece 18 with a centering orifice (no reference number). The projecting stud 59 and the centering orifice are sized so that the projecting stud 59 is received in the centering orifice when the set of batteries 40 is at its intended location in the housing 12. The projecting stud 59 and the centering orifice tend to facilitate placing the set of batteries 40 in the housing 12.

As can be seen in FIG. 4, the interior surface 14 is advantageously inclined toward the ground in a direction away from the opening 13. This inclination toward the surface of the ground facilitates insertion of the set of batteries 40 in the housing 12 and tends to prevent the set of batteries 40 escaping accidentally from the housing 12 when the on-site vehicle 1 is in motion, including on inclined ground.

In a manner that is not represented in the drawings the opening 13 may be closed by a ventilation grill. Furthermore, at the end of the housing 12 opposite the opening 13 the housing 12 may include a ventilation orifice (not represented in the drawings). Thanks to this ventilation grill and this ventilation orifice convection of air can be achieved through the housing 12 that tends to reduce further the risk of accidental overheating of the battery elements 60.

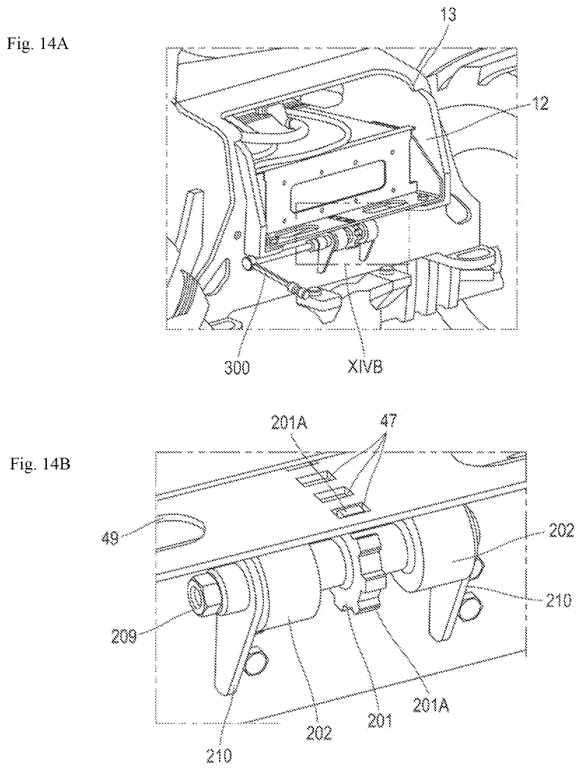

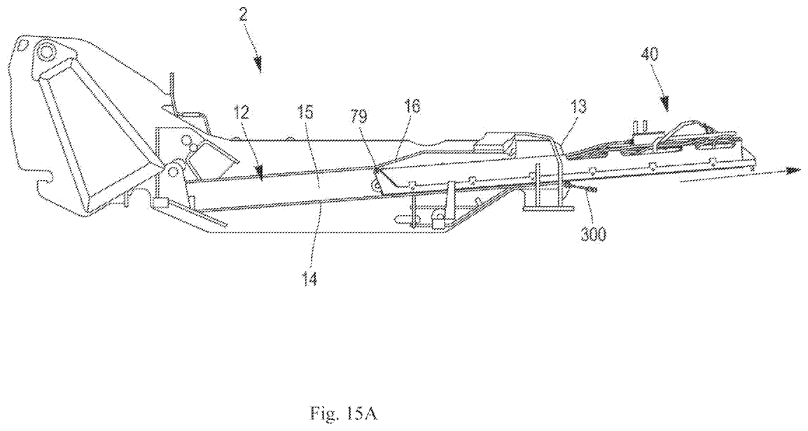

As can be seen in the figures, and in FIG. 13B in particular that shows the set of batteries 40 from the side of the lower face 41B of the support plate 41, the support plate 41 may include a plurality of openings 47 aligned with one another in the lengthwise direction of the set of batteries 40. In this case the chassis 2 is provided with a toothed wheel 201 carried by a shaft 200 that can be seen in FIGS. 14A and 14B. The shaft 200 is mounted and free to rotate between two spaced plates 210 situated in the vicinity of the opening 13 of the housing 12. Bearings 210 retain the toothed wheel 201 in position relative to the plates 210. At one of its ends the shaft 200 is provided with an imprint 209 that enables the shaft 200 to be driven in rotation by a tool 300. Here the tool 300 is a crank that can be actuated by a human operative, but any other type of tool may be suitable. In any event, when the shaft 200 is driven in rotation the teeth 201A of the toothed wheel 201 cooperate with the openings 47 in the support plate 41, in the manner of a rack and pinion, which moves the support plate 41 and therefore the set of batteries 40 in translation. This enables an operative to begin to extract the set of batteries 40 from the housing 12 with the aid of the tool 300, after removing the bolts 99.

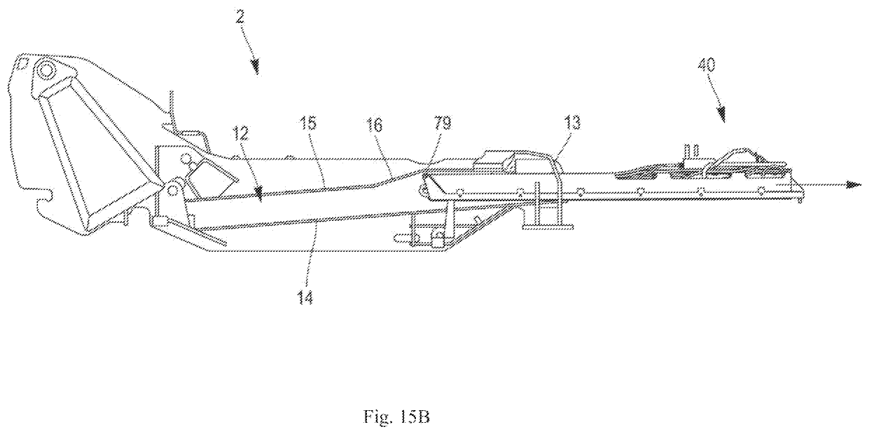

Referring to FIGS. 5A, 5B and 5D, the set of batteries 40 may further include two rollers 79 mounted on and free to rotate on its upper surface. Here the rollers 79 are carried by the rim 43 of the support plate 41. Referring to FIG. 4, the upper surface 15 of the housing 12 includes a flat 16 that is inclined so that a cross section of the housing 12 widens in the direction toward the opening 13. FIGS. 15A and 15B together show that when the set of batteries 40 is extracted from the housing 12 the rollers 79 cooperate with the inclined flat 16. This cooperation tends to facilitate the operation of extraction of the set of batteries 40 from the housing 12. It is clear that the number and/or the dimensions and/or the positioning of the rollers 79 may be modified as long as this cooperation with the inclined flat 16 is present.

Referring to FIGS. 7, 13A and 13B, the support plate 41 can carry on its two longer sides a plurality of projecting elements 115. These projecting elements 115 are able to cooperate with slinging elements. Thus after partially extracting the set of batteries 40 from the housing 12 as shown in FIG. 15B, the operative can install slinging elements, which here are slinging eyelets 120, on the projecting elements 115 and then install slings on the slinging elements, which enables the set of batteries 40 to be lifted and moved.

In addition to this or instead of this it is equally possible to move the set of batteries 40 with the aid of a vehicle such as a forklift truck.

As mentioned hereinabove, a supplementary set of batteries 140 may be disposed between the two side rails 10. This supplementary set of batteries 140 is described next with reference to FIGS. 8A to 8D and 16 and 17.

FIGS. 8A to 8D show that the supplementary set of batteries 140 has a globally parallelepipedal shape and includes battery elements 60 and frame elements 63 identical to those described hereinabove with reference to set of batteries 40. Here the supplementary set of batteries 140 includes two battery elements 60. In a manner that is not represented in the drawings the battery elements 60 are electrically connected to one another and to a supplementary power outlet socket 151 (not represented in FIGS. 8A to 8D) enabling electrical connection of the supplementary set of batteries 140 to the electrical connection unit 50 of the set of batteries 40. A cable guide 184 may be installed on one side of the supplementary set of batteries 140 in order to retain in place and to protect the electrical cables making these electrical connections.

In a variant the supplementary set of batteries 140 may be produced with battery elements of different construction and/or type than the battery elements 60.

Still with reference to FIGS. 8A to 8D, the supplementary set of batteries 140 has a greatest width [symbol] 2 in a widthwise direction of the supplementary set of batteries 140, a greatest length L2 in a lengthwise direction of the supplementary set of batteries 140, and a greatest height h2 in a heightwise direction of the supplementary set of batteries 140, the greatest length L2 being greater than the greatest width [symbol] 2.

The greatest length L2 and the greatest height h2 satisfy the condition h2/L2≤0.20. This means that h2 is relatively small compared to L2, which gives the supplement set of batteries 140 a relatively flat and elongate shape that enables positioning of the supplementary set of batteries 140 in a relatively long housing 112 of relatively low height, as described hereinafter.

Furthermore, the greatest width [symbol] 2 and the greatest height h2 may satisfy the condition h2/ [symbol] 2≤0.30 and/or the greatest length L2 and the greatest width [symbol] 2 may satisfy the condition [symbol] 2/L2≤0.70.

Still with reference to FIGS. 8A to 8D, the battery elements 60 of the supplementary set of batteries 140 rest on a plate 170. The battery elements 60 are for example attached to the plate 170 by the frame elements 63. The plate 170 has a rim 180. The rim 180 advantageously includes a handle 181 that enables an operative to manipulate the supplementary set of batteries 140.

Referring again to FIG. 4, the supplementary set of batteries 140 is received in a supplementary housing 112 formed in the chassis 2 between the side rails 10. The lateral walls of the supplementary housing 112 may be defined by lateral surfaces of the side rails 10. The supplementary housing 112 also has a lower surface 113 on which the plate 170 rests when the supplementary set of batteries 140 is received in the supplementary housing 112.

In a manner that is not represented in the drawings the face of the plate 170 opposite that on which the battery elements 60 rest may be provided with a plurality of polymer skids in order to reduce the friction between the plate 170 and the lower surface 114 of the supplementary housing 112 when inserting the supplementary set of batteries 140 in the supplementary housing 112.

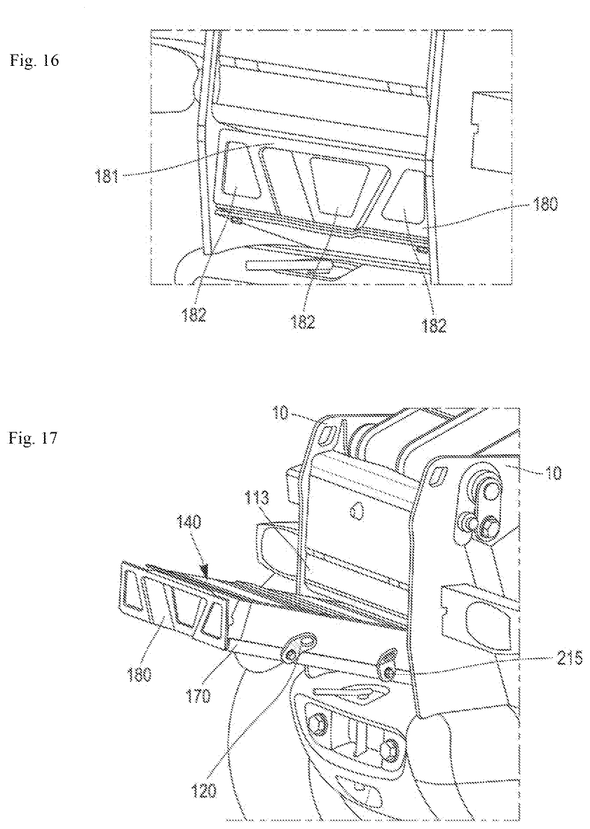

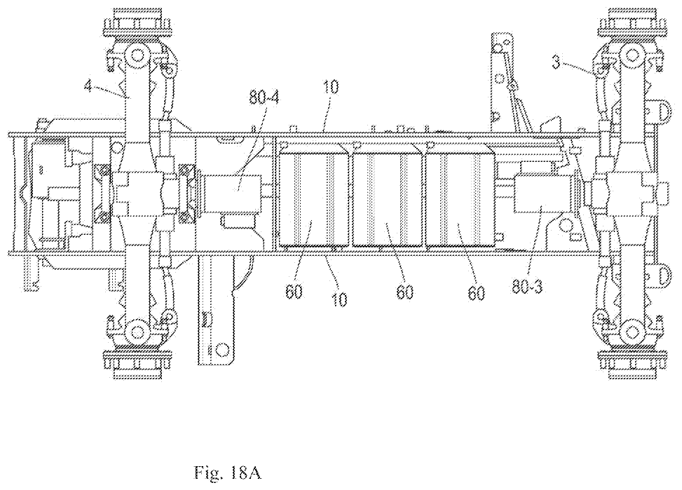

As can be seen better in FIG. 17, the supplementary housing 112 has an opening 113 that is situated at the rear of the on-site vehicle 1 along the front-to-rear axis A-A. FIG. 16 shows that the rim 180 blocks the opening 113 when the supplementary set of batteries 140 is received in the supplementary housing 112.

FIGS. 8A, 16 and 17 show further that the rim 180 is provided with a plurality of (here three) ventilation grills 182. Furthermore, at the end of the supplementary housing 112 opposite the opening 113 the supplementary housing 112 may include a ventilation orifice (not represented in the drawings). Thanks to the ventilation grills 182 and to the ventilation orifice convection of air may be achieved through the supplementary housing 112 that tends to reduce the risk of accidental overheating of the battery elements 60.

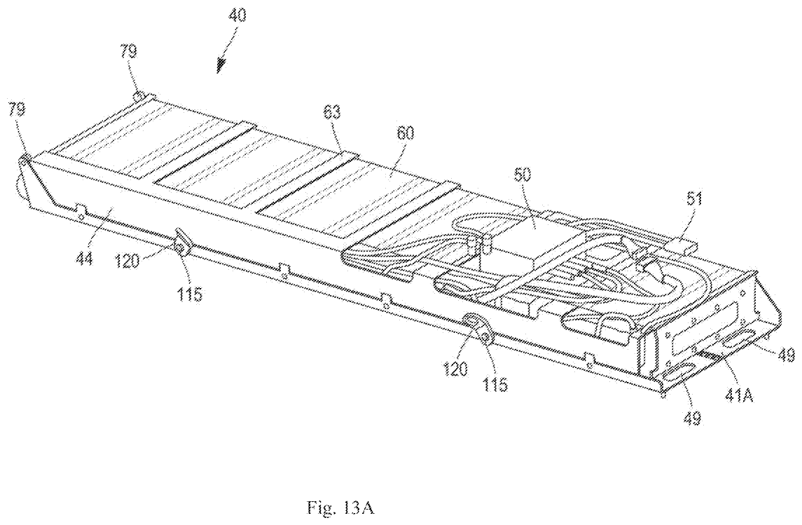

FIGS. 8B to 8D show further that in the rim 180 at its longitudinal end the plate 170 may be provided with a projecting stud 159 of cylindrical or more preferably frustoconical shape. Here the projecting stud 159 is carried by a longitudinal rim 159L that may be attached to the plate 170 or formed in one piece with the plate 170. As represented in FIG. 12, at its end opposite the opening 113 the supplementary housing 112 includes a centering piece 118 provided with a centering orifice (no reference number). The projecting stud 159 and the centering orifice are sized so that the projecting stud 159 is received in the centering orifice when the supplementary set of batteries 140 is in its intended location in the housing 112. The projecting stud 159 and the centering orifice tend to facilitate placing the supplementary set of batteries 140 in the housing 112.

As can be seen in FIG. 4, the lower surface 114 is advantageously inclined toward the ground in a direction away from the opening 113. This inclination toward the surface of the ground facilitates the insertion of the supplementary set of batteries 140 in the supplementary housing 112 and tends to prevent the supplementary set of batteries 140 escaping accidentally from the supplementary housing 112 when the on-site vehicle 1 is in motion, including on sloping ground.

Referring to FIG. 17, the plate 170 may carry on its two longest sides a plurality of projecting elements 215. These projecting elements 215 are analogous to the projecting elements 115 and are able to cooperate with slinging elements. Thus, after partially extracting the supplementary set of batteries 140 from the supplementary housing 112 as shown in FIG. 17, the operative can install slinging elements, which here are slinging eyelets 120, on the project elements 215 and then install slings on the slinging elements, which makes it possible to lift and to move the supplementary set of batteries 140.

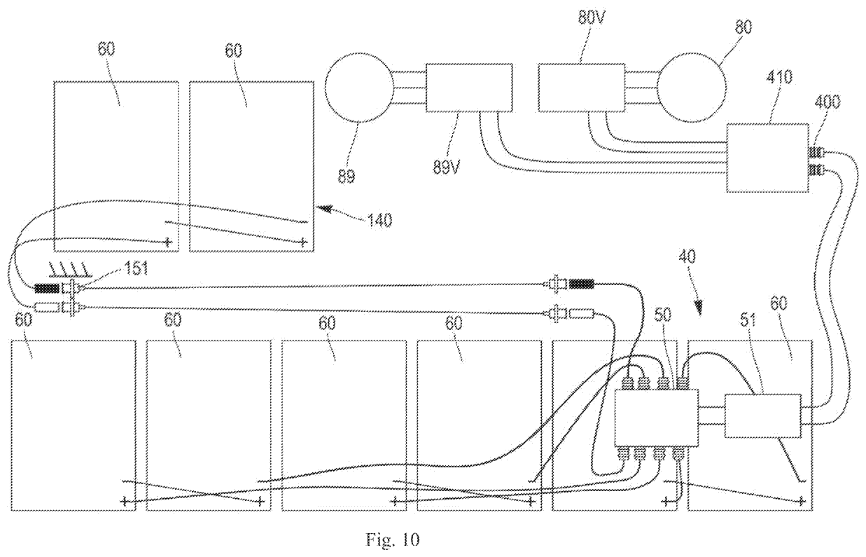

FIG. 10 is a functional diagram representing the supply of electrical power to the on-site vehicle 1 by means of the set of batteries 40 and the supplementary set of batteries 140.

In each of the set of batteries 40 and the supplementary set of batteries 140 the battery elements 60 are connected in series in pairs so that each supplies a voltage of 96 V. The pairs of battery elements 60 are connected in parallel to one another, i.e. three pairs in the set of batteries 40 and one pair in the supplementary set of batteries 140.

As represented in FIG. 10, the supplementary set of batteries 140 is electrically connected to the electrical connection unit 50 via the supplementary power outlet socket 151. The set of batteries 40 and the supplementary set of batteries 140 are electrically connected via the power outlet socket 51 of the set of batteries 140 to a power input socket 400 of the on-site vehicle 1. The supplementary set of batteries 140 therefore contributes to the range of the on-site vehicle 1.

Still referring to FIG. 10, the on-site vehicle 1 includes a power distribution unit 410 that carries the power input socket 400 and is configured to supply to electrical components of the on-site vehicle 1 selectively with power. Power distribution units of this kind are known as such and are not described in detail here.

The power distribution unit 410 is in particular electrically connected to an electrical variable speed drive 80V itself electrically connected to the electric motor 80 and to an electric variable speed drive 89V itself electrically connected to an electric motor 89 to actuate the lifting arm 20. The electrical variable speed drives 80V and 89V are here of the three-phase inverter type, i.e. receiving as input a DC voltage and supplying as output a three-phase AC voltage. Other electrical configurations are nevertheless possible.

In a manner that is not represented in FIG. 10 the power distribution unit 410 may further be electrically connected to other electrical equipment of the on-site vehicle 1, in particular a module for heating the cab 29, and/or a module for air-conditioning the cab 29, and/or one or more DC/DC converters for the supply of electrical power to other electrical equipment of the vehicle, for example a beacon, an audible warning device, etc.

The power distribution unit 410 may for example be received in the box 28. The electrical connection unit 50 is disposed between the side rails 10 because of its position on the set of batteries 40.

In a manner that is not represented in the drawings the electrical connection unit 50 may further be electrically connected to at least one charging socket enabling charging of the battery elements 60 of the set of batteries 40 and where applicable of the set of batteries 140.

The number of battery elements 60 in FIG. 10 is purely indicative. A larger or smaller number of battery elements 60 may be provided, depending on the electrical power requirements of the on-site vehicle 1. Furthermore, it is possible to provide not one but rather a plurality of electrical connection units 50 each electrically connected to one or more pairs of battery elements 60 connected in series in pairs so that each supplies a voltage of 96 V. In this case the electrical connection units 50 are electrically connected in parallel to the power distribution unit 410.

In another embodiment that is not represented the electrical connection unit 50 and the power distribution unit 410 are collocated, for example integrated in the form of a single connection and distribution unit.

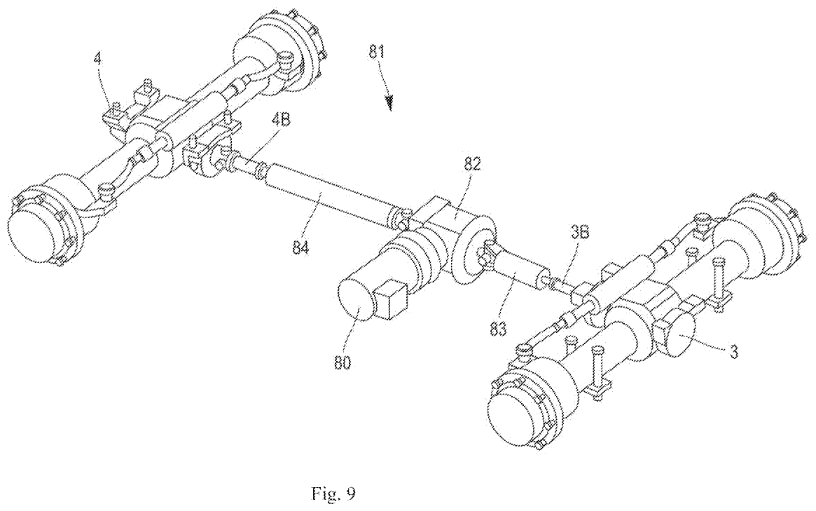

As already mentioned hereinabove, the electric motor 80 propels the chassis 2. Purely by way of example, there has been represented in FIG. 9 a transmission 81 for transmission of power between the electric motor 80 and the axles 3 and 4 of the chassis. An output shaft (not represented) of the electric motor 80 drives two shafts 83 and 84 via a gearbox 82. The shaft 84 drives an input shaft 4B for driving the rear wheels 4A mounted on the rear axle 4 and the shaft 83 drives an input shaft 3B for driving the front wheels 3A mounted on the front axle 3. Note that the shafts 83 and 84 here extend substantially parallel to the front-to-rear axis A-A of the on-site vehicle 1 and therefore to the side rails 10. Note also that the output shaft (not represented) of the electric motor 80 extends under the housing 12 between the side rails 10. Alternatively a large number of other configurations are possible for the transmission 81.

For its part, the electric motor 89 actuates the lifting arm 20. In one example the electric motor 89 drives a hydraulic pump which feeds hydraulic actuators, for example hydraulic cylinders, to actuate the movement of the lifting arm 20. Those movements include for example up and down movements effected by a lifting cylinder situated under the lifting arm 20, extension-retraction movements effected by a telescoping cylinder situated in the lifting arm 20, and movements of the tool-carrier. This kind of hydraulic actuation of the lifting arm 20 is well known as such and is therefore not described in detail here.

The electric motor 80 may be received in the box 28, as represented diagrammatically in the FIG. 2 view in section from below. Some or all of the other components described hereinabove, namely the electrical variable speed drives 80V and 89V, the electric motor 89 and the power distribution unit 410, may equally be received in the box 28. In a variant, the electric motor 80 and/or the electric motor 89 may be situated between two side rails 10 or below the two side rails 10.

In the foregoing description there has been described an on-site vehicle 1 that is entirely electrically powered, that is to say with no internal combustion engine. Nevertheless, in a variant, the on-site vehicle 1 may be of the hybrid type, i.e. the electric motor 80 and/or the electric motor 89 could each be combined with an internal combustion engine and an appropriate transmission for a hybrid drive train in accordance with the known principles for hybrid vehicles. Such a solution may in particular make it possible to increase the torque available for the propulsion of the chassis 2 and/or the actuation of the lifting arm 20, which may be useful for an on-site vehicle 1 to be used under difficult conditions of use.

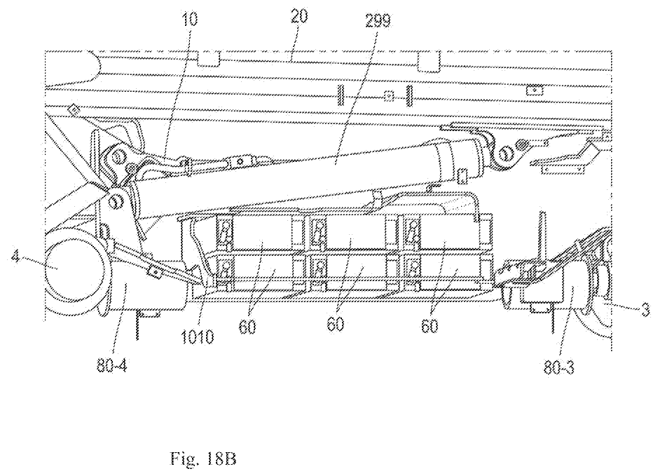

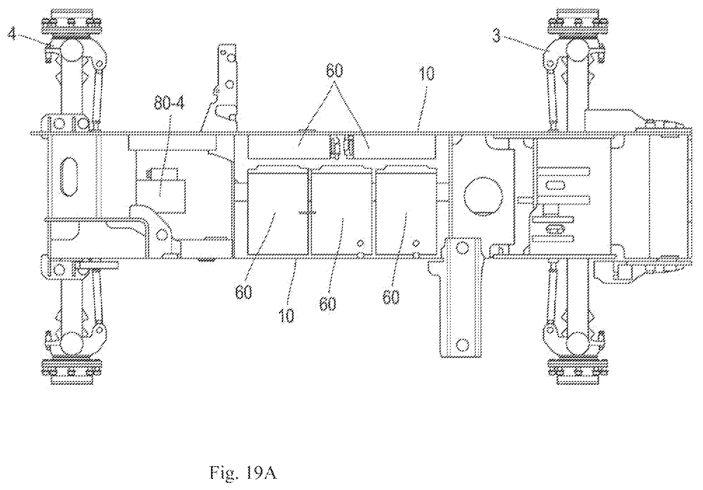

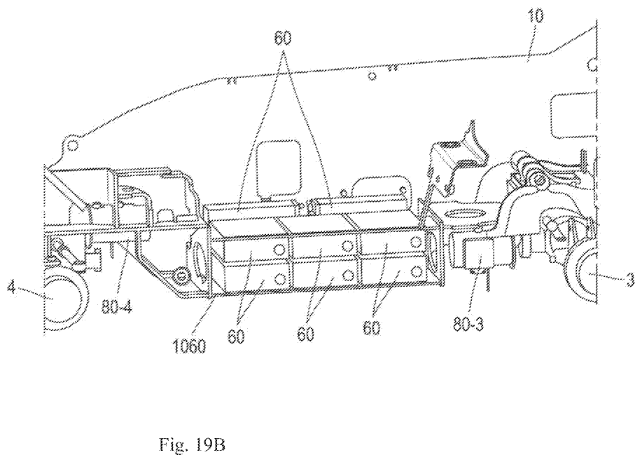

As mentioned hereinabove, a large number of configurations other than that represented in FIG. 9 are possible for the transmission 81. Furthermore, these configurations may be envisaged in combination with arrangements in which the battery elements 60 are disposed between the two side rails 10 but without being supplied in the form of a set of batteries 40 or 140. Examples of configurations within this range are described hereinafter by way of illustration with reference to FIGS. 18A to 21.

FIGS. 18A and 18B partially represent a variant of the on-site vehicle 1. FIG. 18A is a partial view in section from below of the on-site vehicle 1 and FIG. 18B is a perspective view in which one of the side rails 10 having been removed in order to render the battery elements 60 visible.

As can be seen in these figures, here the battery elements 60 are six in number, electrically connected in series in pairs as already described hereinabove. The battery elements 60 are disposed between the two side rails 10 and more specifically housed in a frame 1010 secured to the side rails 10. The bottom of the frame 1010 is not shown in FIGS. 18A and 18B in order to render the battery elements 60 visible.

The battery elements 60 supply electricity to two propulsion electric motors 80-3 and 80-4. The electric motor 80-3 drives an input shaft of the front axle 3, possibly via a gearbox (not represented). Likewise, the electric motor 80-4 drives an input shaft of the rear axle 4, possibly via a gearbox (not represented). Here the output shafts of the electric motors 80-3 and 80-4 are aligned substantially parallel to the front-to-rear axis A-A of the on-site vehicle 1 and therefore the side rails 10.

There has moreover been represented in FIG. 18B a hydraulic cylinder 299 for raising the arm 20. This hydraulic cylinder 299 may be driven by a hydraulic pump itself driven by an electric motor (not represented) that is itself also supplied with electricity by the battery elements 60.

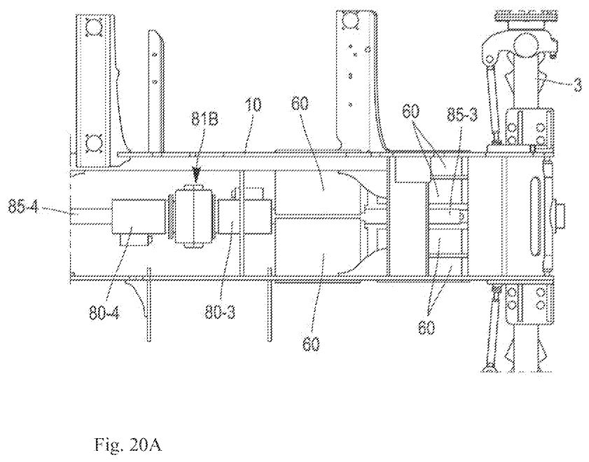

FIGS. 19A and 19B partially represent another variant of the on-site vehicle 1. FIG. 19A is a partial view in section from below of the on-site vehicle 1 and FIG. 19B is a perspective view in which one of the side rails 10 has been removed in order to render visible the battery elements 60.

As can be seen in these figures, here the battery elements 60 are eight in number, electrically connected in series in pairs as already described hereinabove. The battery elements 60 are disposed between the two side rails 10 and are more specifically housed in a frame 1060 secured to the side rails 10. Six of the eight battery elements 60 are stacked on one another in pairs. The last two battery elements 60 (namely those closest to the only side rail 10 that can be seen in FIG. 19B) are for their part disposed face-to-face in the frame 1060.

In this variant the battery elements 60 also supply with electricity two propulsion electric motors 80-3 and 80-4. The electric motor 80-3 drives an input shaft of the front axle 3, possibly via a gearbox (not represented). Likewise, the electric motor 80-4 drives an input shaft of rear axle 4, possibly via a gearbox (not represented). The output shafts of the electric motors 80-3 and 80-4 are here aligned substantially parallel to the front-to-rear axis A-A of the on-site vehicle 1 and therefore the side rails 10. However, unlike the variant in FIGS. 18A and 18B, the propulsion electric motor 80-4 is situated closer to the surface of the ground than the propulsion electric motor 80-3.

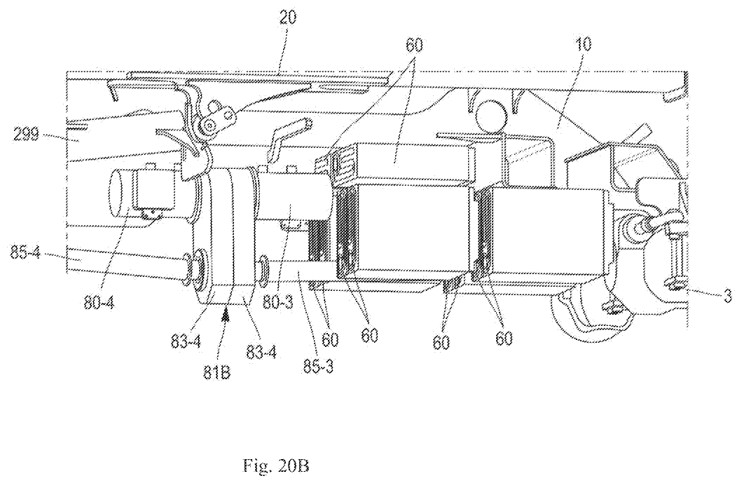

FIGS. 20A and 20B partially represent a further variant of the on-site vehicle 1. FIG. 20A is a partial view in section from below of the on-site vehicle 1 while FIG. 20B is a perspective view in which one of the side rails 10 has been removed in order to render visible the battery elements 60.

As can be seen in these figures the battery elements 60 are here ten in number, electrically connected in series in pairs as already described hereinabove. Four pairs of battery elements 60 are disposed on respective opposite sides of the shaft 85-3 that will be described later; to be more precise, two pairs of battery elements 60 are disposed one on each side of the shaft 85-3. The fifth pair of battery elements 60 is disposed above these four pairs of battery elements 60 and the shaft 85-3. Here the battery elements 60 are also equally received between the two side rails 10 in a frame or a housing that is not represented.

In this variant the battery elements 60 also supply with electricity two electric propulsion motors 80-3 and 80-4. However, the mechanical transmission between these electric motors and the axles 3 and 4 is different.

To be more precise, as seen better in FIG. 20B, a gearbox assembly 81B is disposed between the electric propulsion motors 80-3 and 80-4. The gearbox assembly 81B comprises two gearboxes 83-3 and 83-4 each gearbox 83-3 and 83-4 being covered by a half-casing, the two half-casings being placed back-to-back and fastened together so as to form a complete casing of the gearbox 81B. In a variant, each gearbox 83-3, 83-4 could be received in a complete casing, the two casings being placed back-to-back and fastened together.

The electric propulsion motor 80-3 drives via the gearbox 83-3 a shaft 85-3 for driving the front axle 3. Likewise, the electric propulsion motor 80-4 drives via the gearbox 83-4 a shaft 85-4 for driving the rear axle 4. As mentioned hereinabove, the shaft 85-3 passes between four pairs of battery elements 60.

The shaft 85-3 and the shaft 85-4 extend substantially parallel to the front-to-rear axis A-A of the on-site vehicle 1 and therefore to the side rails 10. The shaft 85-3 and the shaft 85-4 are nevertheless not necessarily in line with one another. For example, in the example represented in FIG. 20B the shaft 85-3 and the shaft 85-4 are situated in the same plane but their longitudinal directions are at an angle other than 180 degrees. Thus the shaft 85-3 and/or the shaft 85-4 may be inclined relative to the surface of the ground.

There has also been represented in FIG. 20B a hydraulic cylinder 299 for raising the arm 20. This hydraulic cylinder 299 may be driven by a hydraulic pump itself driven by an electric motor (not represented) which is also supplied with electricity by the battery elements 60.

In the examples described above the front axle 3 and the rear axle 4 are driven by one or more electric propulsion motors via a mechanical transmission. Nevertheless, other configurations are possible, and in particular a hydraulic transmission. Thus in all the foregoing examples one or each electric motor may be replaced by a hydraulic motor having the same function as the electric motor.

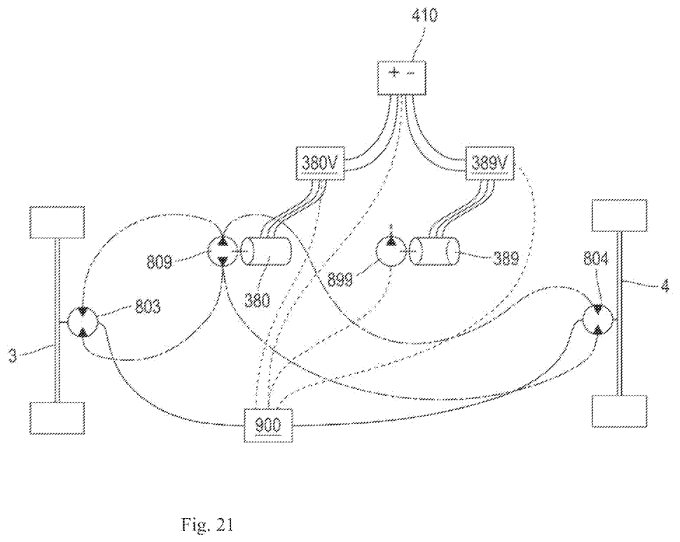

FIG. 21 is a functional diagram representing one example of a hydraulic transmission of this kind. In this diagram the curved solid lines represent electrical connections, the curved dashed lines represent control by a control unit, and the curved chain-dotted lines represent supply of hydraulic fluid.

As represented in this figure, a hydraulic motor 803 is coupled to the front axle 3 and a hydraulic motor 804 is coupled to the rear axle 4. A hydraulic pump 809 generates a hydraulic flow driving the hydraulic motors 803 and 804. The hydraulic pump 809 is driven by an electric motor 380, this electric motor 380 being supplied with electricity by the battery elements 60. In the example represented in FIG. 21 the electric motor 380 is supplied with electricity by the battery elements 60 via an electrical variable speed drive 380V. The electric variable speed drive 380V is itself electrically connected to the power distribution unit 410 described above. The electric variable speed drive 380V may be of the three-phase inverter type. Other electrical configurations are nevertheless possible.

To actuate the lifting arm 20 another electric motor 389 drives a hydraulic pump 899. The hydraulic pump 899 feeds hydraulic actuators in a manner known in itself as already described hereinabove. The electric motor 389 is supplied with electricity by the battery elements 60 via an electrical variable speed drive 389V. The electrical variable speed drive 389V is itself electrically connected to the power distribution unit 410 described above. The electrical variable speed drive 389V may be of the three-phase inverter type. Other electrical configurations are nevertheless possible.

A control unit 900, which may also be supplied with electricity by the battery elements 60, controls the actuation of the hydraulic motors 803 and 804, the hydraulic pump 899 and the electric variable speed drives 380V and 389V.

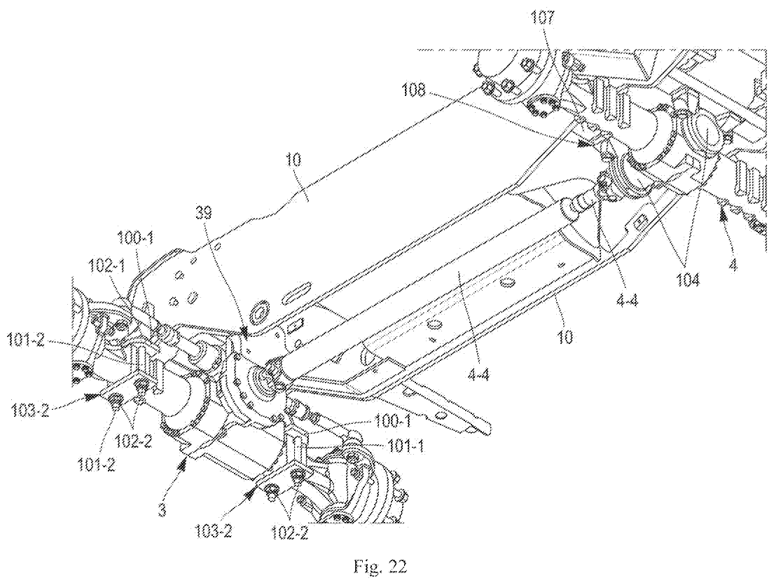

FIG. 22 partially represents another variant of the on-site vehicle 1. In this variant the electric motor 80 drives the front axle 3 via a gearbox 39 integrated into the front axle 3. In this case an input shaft 4-4 of the rear axle 4 is driven via a transmission shaft 34 itself driven by the electric motor 80 via the gearbox 39.

It is also seen in FIG. 22 that the front axle 3 is fixed to one of the side rails 10 via a plate 100-1 secured to that side rail 10 and to the other side rail 10 via a plate 100-2 secured to that other side rail 10.

In more concrete terms the front axle 3 is fixed to the plate 100-1 by means of two studs 101-1. The studs 101-1 are threaded at both ends. Nuts 102-1 are screwed onto the two ends of the studs 101-1 so as to clamp the plate 100-1 and a counter-plate 103-1 (cf. FIG. 3) between the front axle 3 and thus to hold the front axle 3 firmly in place relative to the side rail 10. The front axle 3 is fixed in exactly the same way to the plate 100-2 by means of two studs 101-2 threaded at both ends, four nuts 102-2 and a counter-plate 103-2.

Still referring to FIG. 22, the rear axle 4 is fixed to the side rails 10 via two rear support plates 107 each secured to the two side rails 10. A radial bearing 108 is fixed, here bolted, to each of the rear support plates 107. The rear axle 4 includes two journals 104. Each of the journals 104 is received in a radial bearing 108. The rear axle 4 is therefore retained in position relative to the chassis 2 in the longitudinal direction A-A but able to pivot relative to the chassis 2. The manner that has just been described of fixing the front axle 3 and the rear axle 4 to the side rails 10 may be employed in all the variants of the on-site vehicle 1 described above.

Although the invention has been described with reference to a plurality of particular embodiments it is obvious that it is in no way limited to them and that it encompasses all technical equivalents of the means described and combinations thereof if the latter fall within the scope of the invention.

Use of the verbs “to include”, “to comprise” and conjugate forms thereof does not exclude the presence of elements or steps other than those stated in a claim.

In a claim, any reference sign between parentheses should not be interpreted as a limitation of the claim.

1. An on-site vehicle comprising:
a mobile chassis movable over a surface of the ground, the chassis including two parallel side rails extending parallel to a longitudinal axis of the vehicle;
a lifting arm extending parallel to the longitudinal axis of the vehicle, the lifting arm being articulated to the two side rails between the two side rails so as to be pivotable relative to the two side rails about a pivot axis extending perpendicularly to the longitudinal axis of the vehicle;
at least two battery elements disposed between the two side rails and below the lifting arm; and
at least one electric motor for the propulsion of the chassis and for the actuation of the lifting arm, the at least two battery elements being electrically connected to the at least one electric motor to supply power to the at least one electric motor.

2. The on-site vehicle of claim 1, wherein the battery elements are disposed on respective opposite sides of the longitudinal axis with a substantially balanced weight distribution relative to the longitudinal axis.

3. The on-site vehicle of claim 1, further including a front axle mounted on a front end portion of the chassis, a rear axle mounted on a rear end portion of the chassis, and at least one transmission coupling the at least one electric motor to one or both of the front axle or the rear axle.

4. The on-site vehicle of claim 3, wherein the battery elements are disposed between the front axle and the rear axle.

5. The on-site vehicle of claim 3, wherein the at least one electric motor includes an electric propulsion motor for the propulsion of the chassis, the battery elements are electrically connected to the electric propulsion motor via an electrical variable speed drive, and the at least one transmission includes a mechanical transmission or hydraulic transmission that couples the electric propulsion motor to one or both of the front axle and/or the rear axle.

6. The on-site vehicle of claim 3, wherein the at least one electric motor includes a first propulsion electric motor coupled to the front axle by a first mechanical transmission and a second propulsion electric motor coupled to the rear axle by a second mechanical transmission.

7. The on-site vehicle of claim 3, wherein the at least one transmission includes a hydraulic transmission that couples the at least one electric motor to the front axle and/or the rear axle, the hydraulic transmission including at least one hydraulic pump driven by the at least one electric motor and at least one hydraulic motor driven by a hydraulic flow generated by the at least one hydraulic pump, the at least one hydraulic motor being coupled to one or both of the front axle and/or the rear axle.

8. The on-site vehicle of claim 1, wherein the at least one electric motor includes an actuator electric motor for actuation of the lifting arm, the battery elements being connected to the actuator electric motor via an electric variable speed drive.

9. The on-site vehicle of claim 8, wherein the actuator electric motor includes at least one electric cylinder configured to actuate at least one movement of the lifting arm.

10. The on-site vehicle of claim 8, further including a hydraulic pump coupled to the actuator electric motor and to at least one hydraulic actuator fed by the hydraulic pump to actuate at least one movement of the lifting arm.

11. The on-site vehicle of claim 1, further including a cab for a driver of the on-site vehicle, the cab projecting on one lateral side of the chassis of the on-site vehicle.

12. The on-site vehicle of claim 1, wherein the chassis includes a housing that receives the battery elements, the housing having an opening that opens in a direction chosen from a front of the on-site vehicle, a rear of the on-site vehicle, an upper side of the chassis, an underside of the chassis, and a lateral direction away from a cab of the on-site vehicle.

13. The on-site vehicle of claim 12, wherein the housing has a lower surface on which the battery elements rest directly or indirectly, the lower surface being inclined toward the surface of the ground in a direction away from the opening.

14. The on-site vehicle of claim 12, wherein the opening of the housing is closed by a ventilation grill.

15. The on-site vehicle of claim 12, wherein the housing includes a ventilation orifice at a distance from the opening.

16. The on-site vehicle of claim 1, further including supplementary battery elements for supplying electrical power to the at least one electric motor of the on-site vehicle, the supplementary battery elements being disposed between the two side rails, wherein the chassis includes a supplementary housing that receives the supplementary battery elements, the supplementary housing including an opening that opens toward a rear of the on-site vehicle and a lower surface on which the supplementary battery elements rest directly or indirectly.

17. The on-site vehicle of claim 1, wherein the at least two battery elements are part of a parallelepipedal set of batteries, the set of batteries including a support plate, the at least two battery elements being fixed to an upper face of the support plate relative to a heightwise direction of the set of batteries, and the set of batteries having a greatest width in a widthwise direction of the set of batteries, a greatest length in a lengthwise direction of the set of batteries, and a greatest height in the heightwise direction of the set of batteries, the greatest length being greater than the greatest width, and the greatest height being less than or equal to four tenths of the greatest length.

18. The on-site vehicle of claim 17, further including a power input socket, wherein the set of batteries further includes:
an electrical connection unit electrically connected to the battery elements; and
a power outlet socket electrically connected to an outlet of the electrical connection unit and electrically connectable to the power input socket.

19. The on-site vehicle of claim 17, wherein the greatest height is less than or equal to six tenths of the greatest width.

20. The on-site vehicle of claim 17, wherein the greatest width is less than or equal to three tenths of the greatest length.

21. The on-site vehicle of claim 17, wherein the support plate includes a plurality of polymer skids on a lower face opposite the upper face to which the battery elements are fixed.

22. The on-site vehicle of claim 17, wherein the support plate has at one of its ends, in the lengthwise direction, two through-orifices, the through-orifices being sized to enable a human operative to raise the end of the set of batteries by seizing the support plate through the two through-orifices.

23. The on-site vehicle of claim 17, wherein the support plate carries a plurality of elements projecting in one or both of the widthwise direction or in the lengthwise direction, the projecting elements being adapted to cooperate with a plurality of slinging elements.

24. The on-site vehicle of claim 17, wherein the battery elements are lithium-ion battery elements.

25. The on-site vehicle of claim 17, wherein the chassis includes a housing that receives the set of batteries, the housing including an opening that opens toward a front or rear of the on-site vehicle and a lower surface on which the set of batteries rests directly or indirectly.

26. The on-site vehicle of claim 25, wherein the lower surface of the housing is inclined toward the surface of the ground in a direction away from the opening of the housing.

27. The on-site vehicle of claim 25, wherein the housing has an upper surface facing the lower surface, the upper surface featuring an inclined portion such that a cross section of the housing widens in the direction toward the opening.

28. The on-site vehicle of claim 25, wherein the set of batteries further includes at least one roller mounted and free to rotate on an upper surface of the set of batteries, the roller being adapted to cooperate with an inclined flat portion when the set of batteries is extracted from the housing via the opening of the housing.

29. The on-site vehicle of claim 25, wherein the support plate includes a plurality of openings, the plurality of openings being aligned with one another in the lengthwise direction of the set of batteries, and the chassis includes a shaft situated proximate to the opening of the housing, the shaft carrying a toothed wheel adapted to cooperate with the plurality of openings in the support plate and thus to move the support plate in translation when the shaft is driven in rotation.

30. The on-site vehicle of claim 25, wherein the set of batteries further includes a projecting stud at one longitudinal end of the set of batteries, the projecting stud being received in a centering orifice situated at an end of the housing that is opposite the opening of the housing.
